(19) United States
(12) Patent Application Publication
(10) Pub. No.: US 2026/0061354 A1
(43) Pub. Date: Mar. 5, 2026

(54) FILTRATION APPARATUS FOR REMOVING PARTICULATE MATERIAL FROM BIOMASS COMBUSTION EXHAUST

(71) Applicant: STURGEON CREEK WELDING LTD., Headingley (CA)

(72) Inventor: David MAENDEL, Headingley (CA)

(21) Appl. No.: 19/316,703

(22) Filed: Sep. 2, 2025

Related U.S. Application Data
(60) Provisional application No. 63/690,555, filed on Sep. 4, 2024.

(51) Int. Cl. B01D 46/42; A23B 9/02; A23B 9/08; B01D 39/10; B01D 46/00; B01D 46/16; B01D 46/44; B01D 46/46; B01D 46/52; B01D 46/70; F26B 23/02

(52) U.S. Cl. CPC B01D 46/4227; B01D 39/10; B01D 46/0002; B01D 46/0086; B01D 46/16; B01D 46/446; B01D 46/46; B01D 46/521; B01D 46/70; A23B 9/025; A23B 9/08; B01D 2271/022; F26B 23/022; F26B 2200/06

(57) ABSTRACT

A filtration apparatus is disclosed. The filtration includes a housing with an exhaust passage; and a filter screen supported within the exhaust passage. An operating linkage moves the filter screen between first and second configuration. In the first configuration, the exhaust flow passes through the filter screen in the flow direction from a first side to a second side of the filter screen. In the second configuration, the exhaust flow passes through the filter screen in the flow direction from the second side to the first side of the filter screen. The operating linkage allows convenient and optional automation of the reversal of the flow direction through the filtration screen so that the filter screen is self cleaning.

### RELATED APPLICATION

The present application claims 35 U.S.C. 119 priority from U.S. Provisional Application Ser. No. 63/690,555 filed on Sep. 4, 2024, entitled, “Filtration Apparatus for Removing Particulate Material from Biomass Combustion Exhaust”, which is hereby incorporated by reference in its entirety.

### FIELD OF THE INVENTION

The present invention relates to a filtration apparatus receiving a flow of exhaust gases containing particulate material therein, for example sparks or embers, for removal of the particulate material from the exhaust flow, and more particularly the present invention relates to a filtration apparatus for filtering particulate material biomass combustion exhaust.

### BACKGROUND

In the field of grain drying, it is common to direct a flow of heated air from combustion of a fuel through a grain dryer to remove excess moisture from the grain. Biomass is known to be used as a fuel in various types of combustion furnaces to derive heat energy from the biomass, but generally considered unsuitable as a heat source for a grain dryer in view of the possible presence of sparks or embers in the exhaust flow from biomass combustion which pose a considerable risk of fire within the grain dryer. Simple filtration of the exhaust is cumbersome due to common filter screens being quickly plugged with particulate material from the biomass combustion exhaust, requiring frequent replacement.

### SUMMARY

According to one aspect of the invention there is provided a filtration apparatus for removing particulate material from an exhaust flow generated by combustion of biomass, the system comprising:
a housing defining an exhaust passage extending through the housing in a flow direction from an inlet opening arranged to receive the exhaust flow therein to an outlet opening arranged to discharge the exhaust flow therefrom;
a filter screen supported within the exhaust passage of the housing, the filter screen allowing the exhaust passage to pass therethrough between a first side of the filter screen and an opposing second side of the filter screen while preventing passage of the particulate material through the filter screen between the first side and the second side of the filter screen;
an operating linkage supporting the filter screen and the housing to be movable relative to one another between (i) a first configuration in which the exhaust flow passes through the filter screen in the flow direction from the first side to the second side of the filter screen and (ii) a second configuration in which the exhaust flow passes through the filter screen in the flow direction from the second side to the first side of the filter screen.

The operating linkage allows convenient and optional automation of the reversal of the flow direction through the filtration screen so that the filter screen is self cleaning. Any sparks or embers which have been trapped on the intake side of the filter will typically be extinguished before the filter screen is reversed so that the remaining particulate material can be safely carried away from the filter to the outlet side of the apparatus and on to the grain dryer after reversing the filter screen.

### BRIEF DESCRIPTION OF THE DRAWINGS

One embodiment of the invention will now be described in conjunction with the accompanying drawings in which:

FIG. 1 is a schematic representation of the filtration apparatus according to the present invention shown in use between a biomass furnace and a grain dryer according to one exemplary embodiment;

FIG. 2 is a perspective view of the filtration apparatus according to the present invention;

FIG. 3 is a schematic view of the filtration apparatus displace between a first operating configuration and a second operating configuration;

FIG. 4 is a perspective view of the filtration apparatus with the boundary walls of the housing removed for illustrative purposes;

FIG. 5 is an end elevational view of the filtration apparatus;

FIG. 6 is a side elevational view of the filtration apparatus;

FIG. 7 is a top plan view of the filtration apparatus with the upper boundary wall shown removed for illustrative purposes;

FIG. 8 is a perspective view of the filtration screen mounted on a screen frame, shown removed from the filtration apparatus; and

FIG. 9 is a partly sectional view of the filtration screen according to FIG. 8.

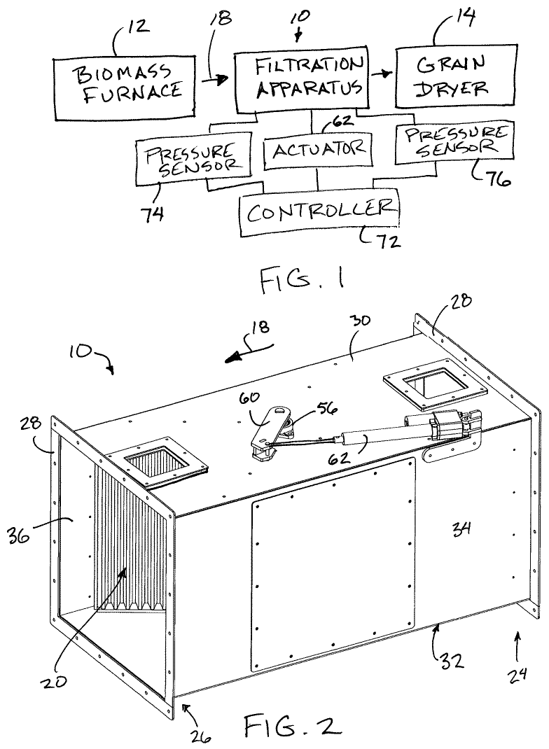

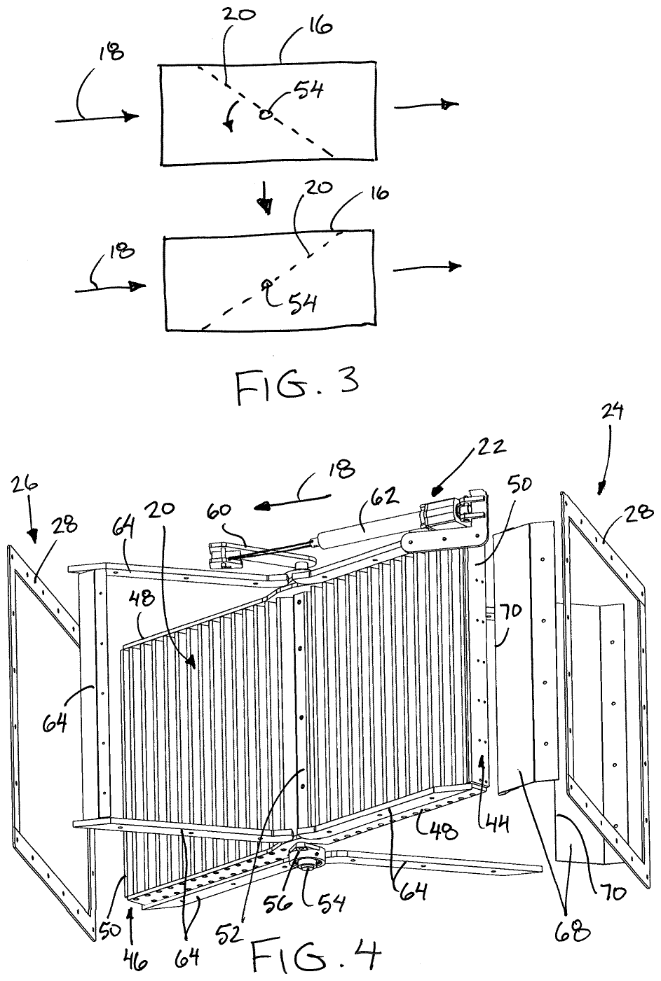

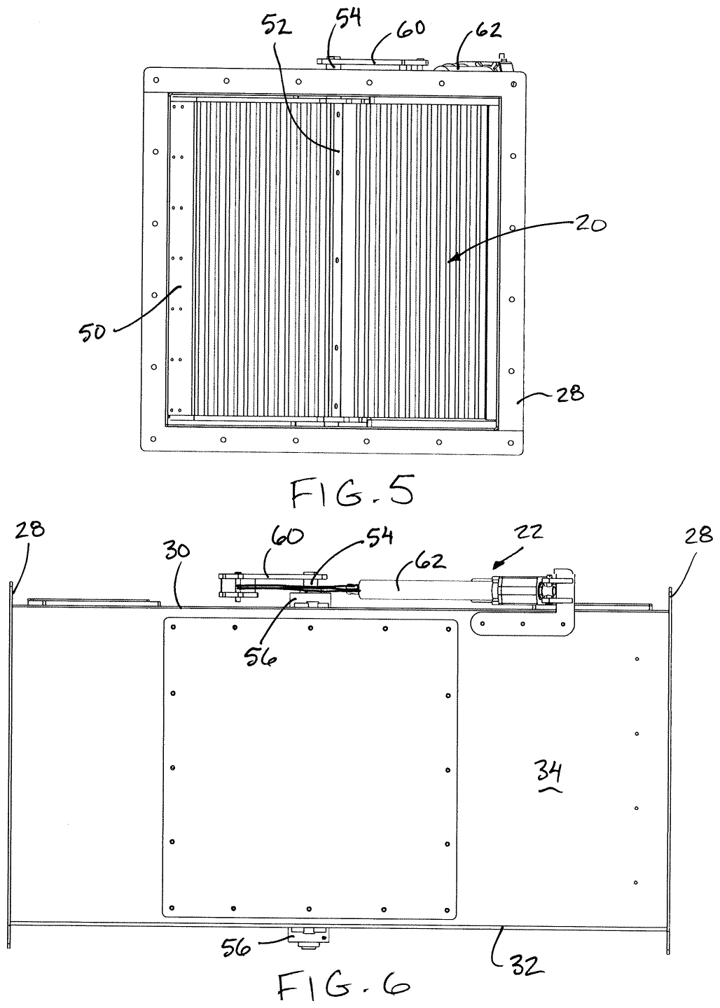

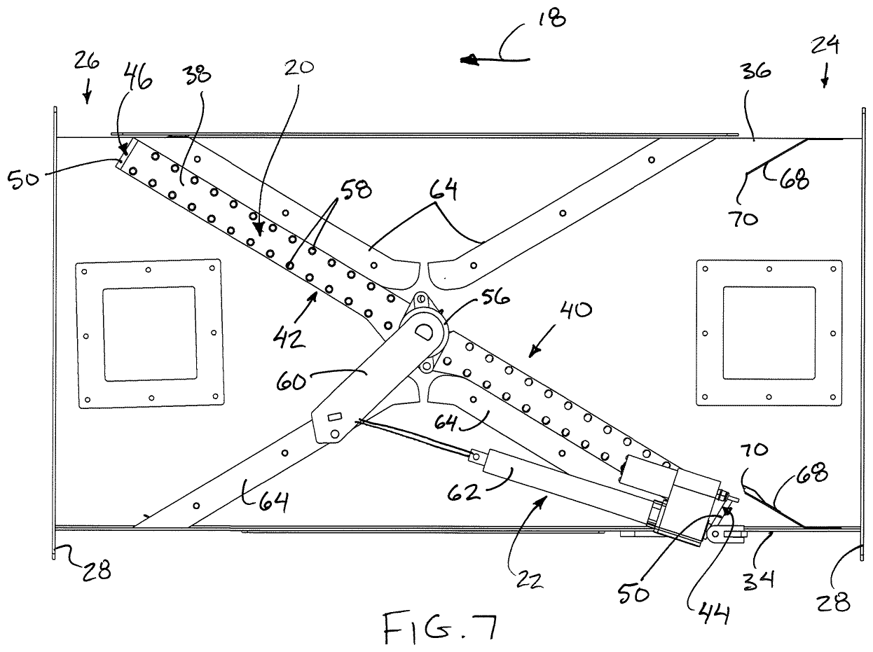

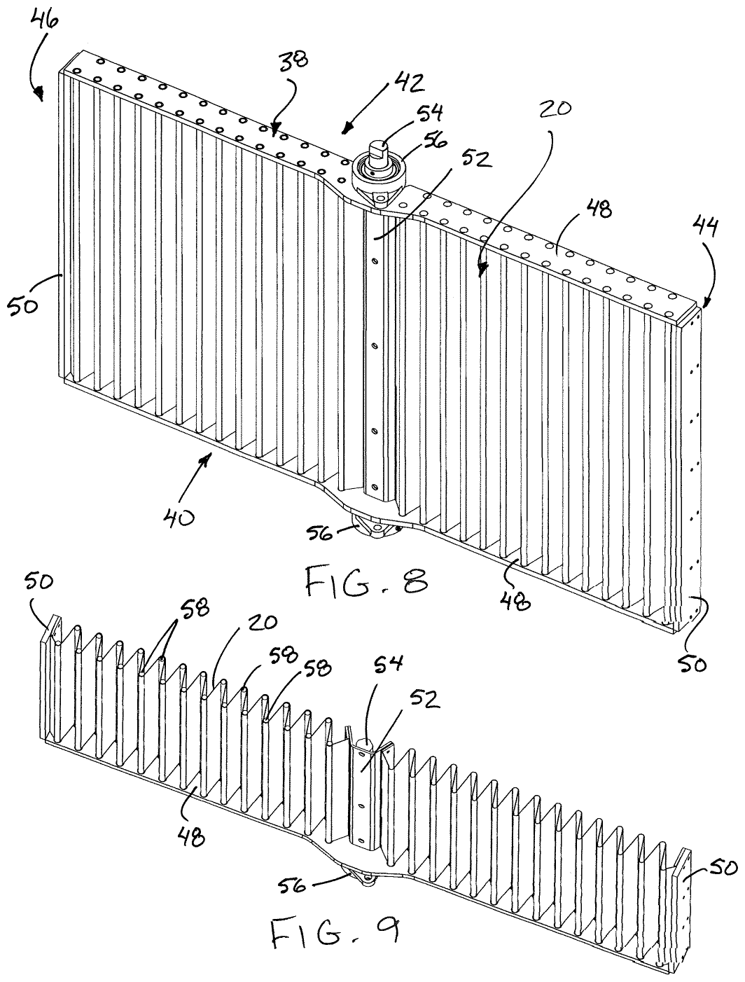

In the drawings like characters of reference indicate corresponding parts in the different figures.

### DETAILED DESCRIPTION

Referring to the accompanying figures there is illustrated a biomass exhaust filtration apparatus 10. The apparatus 10 is particularly suited for use with a biomass furnace 12 that combust biomass therein such that the filtration apparatus filters the exhaust discharged from the biomass furnace resulting from combustion of the biomass therein. More particularly, the filtration apparatus 10 removes particulate material such as sparks or embers which are carried in the exhaust flow from the remaining gaseous portion of the exhaust flow which passes through the exhaust apparatus 10. The apparatus 10 discharges exhaust therefrom into a grain dryer 14 according to the illustrated embodiment. The apparatus 10 is thus mounted end to end in series between the exhaust discharge of the biomass furnace 12 and the heated air intake of the grain dryer 14 that receives air heated by the biomass furnace for drying grain therein.

The filtration apparatus 10 generally includes (i) a housing 16 defining an exhaust passage extending through the housing in a flow direction 18, (ii) a filter screen 20 mounted within the exhaust passage in the housing to receive the flow of exhaust gases through the filter screen for filtration of particulate material carried in the gas flow, and (iii) an operating linkage 22 supporting the filter screen and the housing to be movable relative to one another between a first configuration in which the exhaust flow passes through the filter screen in the flow direction from a first side to an opposing second side of the filter screen and a second configuration in which the exhaust flow passes through the filter screen in the flow direction in the opposing direction from the second side to the first side of the filter screen. In a preferred embodiment, the filter screen 20 is pivotal about a pivot axis relative to the housing between the first and second operating configurations.

The housing 16 is generally rectangular in shape while being elongated to extend in a longitudinal direction corresponding to the flow direction 18 from an inlet end 24 to outlet end 26 of the housing. Boundary walls surround the exhaust passage along the length of the housing between the inlet end and the outlet end. The inlet end 24 defines an inlet opening therein substantially fully spanning the inlet end of the housing for open communication of the exhaust passage with the chimney or exhaust discharge of the biomass furnace 12. Likewise, the outlet end 26 defines an outlet opening therein substantially fully spanning the outlet end of the housing for open communication of the exhaust passage with the downstream grain dryer 14.

Mounting flanges 28 protrude radially outward about a full perimeter of the housing at both the inlet and outlet ends with fastener apertures therein for connection to suitable upstream and downstream ducting which connects the apparatus to the biomass furnace 12 and the grain dryer 14 respectively.

The boundary walls of the housing 16 include a top end wall 30 and a bottom end wall 32 situated along opposing boundaries of the housing at opposing ends of the pivot axis of the filter screen so as to receive opposing top and bottom ends of the filter screen substantially abutted against the top end wall 30 and the bottom end wall 32 respectively. The boundary walls also include a first side wall 34 and a second side wall 36 at laterally opposing sides of the housing in which each of the side walls extends in the direction of the pivot axis of the filter screen such that each side wall 34 or 36 extends between the top end wall and the bottom end wall respectively. In this instance the first and second end walls 30 and 32, together with the first and second side walls 34 and 36 collectively extend about the full circumference of the exhaust passage along the full length thereof between the inlet end 24 and the outlet end 26 of the housing.

The filter screen 20 is supported on a screen frame 38 which is generally flat and rectangular so as to be primarily situated within a single plane. The screen frame 38 supports the filter screen such that the screen is mounted in the exhaust passage of the housing to fully spanning the passage and force the flow of exhaust gases through the filter screen in each of the first and second operating configurations. The screen 20 is supported on the screen frame 38 so that the gaseous portion of the exhaust flow can pass through the filter screen between opposing first and second sides 40 and 42 of the filter screen.

The screen frame 38 is elongated in a longitudinal direction of the filter screen between a first end 44 and an opposing second end 46 of the screen. Longitudinal frame members 48 extend along opposing boundaries of the screen frame between the first and second ends of the frame. End frame members 50 span the full height of the frame 38 at each of the opposing first and second ends, 44 and 46, such that the longitudinal frame members 48 are connected between respective opposing ends of the end frame members 50. The longitudinal frame members 48 and the end frame members 50 collectively extend about the full perimeter of the screen frame. An intermediate frame member 52 is joined between the longitudinal frame members 48 at a longitudinally centred location between the first end 44 and the second end 46 so as to be parallel to the end frame members 50. The screen frame 38 remains fully open at each of the opposing first side 40 and second side 42 of the frame 38 between the frame members described above.

A pivot shaft 54 is mounted on the screen frame alongside the intermediate frame member 52 which follows a generally arcuate path to extend partway about the circumference of the pivot shaft 54. The pivot shaft is thus centrally located between opposing ends 44 and 46 of the screen frame. Opposing ends of the pivot shaft 54 are mounted rotatably on the top end wall 30 and bottom end wall 32 of the housing by suitable bearings 56 which support the screen frame to be readily pivotal relative to the housing 16 between the first configuration and the second configuration. The opposing ends of the pivot shaft 54 extend through the corresponding boundary walls to be situated externally of the exhaust passage of the housing 16.

The filter screen 20 comprises a woven metallic wire mesh forming a sheet which is supported on the screen frame in a corrugated manner. The screen is supported in two sections such that each section spans a full height between opposing longitudinal members 48 while spanning longitudinally between the intermediate frame member 52 and a respective one of the end frame members 50 at the first end 44 or second end 46. Within each section, two rows of support bars 58 are mounted between the longitudinal frame members 48 parallel to the pivot shaft. The wire mesh filter screen 20 extends around bars 58 from alternating rows in a sinusoidal or zigzag pattern such that the filter screen is corrugated to maximize the surface area of the filter screen while supporting the filter screen to fully occupy the openings in the screen frame. The sizing of the wires and the openings in the wire mesh of the filter screen are configured such that the gaseous portion of the exhaust flow readily passes through the filter screen between the first side 40 and second side 42 of the frame while particulate matter carried in the exhaust flow is captured and collected on the leading side of the filter screen in the flow direction.

The operating linkage 22 includes a crank arm 60 mounted on one of the ends of the pivot shaft 54 externally of the housing. A linear actuator 62 is coupled between the housing 16 and the crank arm 60 at a location spaced radially from the pivot shaft such that linear extension and retraction of the actuator 62 causes the crank arm 60 to be rotated which in turn causes the pivot shaft and the screen frame connected thereto to be similarly pivoted relative to the housing together with the crank arm. In this manner the actuator 62 drives pivotal movement of the filter screen between the first and second configurations thereof.

In further embodiments, the actuator 62 may include a variety of other powered actuators including electric or hydraulic actuators or motors that are linear or rotary in configuration while being coupled by a suitable linkage to drive movement of the screen between the first and second configurations thereof.

In the first configuration, the first end 44 of the filter screen is positioned adjacent the first side wall 34 and the second end 46 of the filter screen is positioned adjacent the second side wall 36 while the filter screen spans the full height between the top and wall 30 and the bottom and wall 32. In this manner the filter screen fully occupies the cross-sectional flow area of the exhaust passage so that exhaust gasses must pass through the filter screen from the first side 40 to the second side 42 thereof. The longitudinal frame members 48 are positioned in close proximity to the top and bottom end walls for movement along or in sliding contact with the walls as the screen is pivoted from the first configuration to the second configuration. The plane of the screen frame is supported at a slope of less than 45 degrees from the flow direction in the first configuration, for example of a slope of between 25 degrees and 45 degrees. More preferably, the screen frame is sloped to the flow direction at an angle of between 30 and 40 degrees.

In the second configuration, the first end 44 of the filter screen is positioned adjacent the second side wall 36 and the second end 46 of the filter screen is positioned adjacent the first side wall 34, while the filter screen remains spanning the full height between the top end wall 30 and the bottom end wall 32. The screen is pivoted about a pivot axis defined by the pivot shaft 54 from the first configuration to the second configuration through a range of less than 90 degrees. The screen frame 38 is sloped in the other direction away from the flow direction in the second configuration compared to the first configuration while the amount of slope remains substantially identical to the first configuration so as to be between 25 and 45 degrees, and more preferably between 30 and 40 degrees from the flow direction.

To prevent the exhaust flow from bypassing around perimeter edges of the screen frame, sealing flanges 64 are mounted on the interior of the boundary walls that align with the perimeter edges of the screen frame in both the first and second configurations without inhibiting pivotal movement of the screen frame between the first and second configurations. A compressible gasket may be mounted along one or all of the sealing flanges 64 so that the gasket is compressed between the screen frame and the sealing flanges on the boundary walls of the housing as the screen frame is displaced into the corresponding first or second configuration.

A pair of intake flanges 68 are mounted on the first and second side walls 34 and 36 of the housing respectively to be immediately upstream of the end of the filter screen at the leading side in each of the first and second configurations respectively. Each intake flange spans the full height of the side wall 36 between the top end wall 30 and the bottom end wall 32 while being sloped laterally inwardly and into the flow direction. Each intake flange terminates at an inner edge 70 freely supported within the exhaust passage at a distance from the corresponding side wall corresponding approximately to the protruding distance of the corresponding end of the screen frame immediately trailing the intake flange 68 in a respective one of the first or second configurations. The intake flanges 68 serve to deflect the gas flow laterally inwardly around the end frame member 50 at the leading end of the screen to further encourage all gaseous flow to pass through the filter screen between the first side and the second side thereof.

The apparatus further includes a controller 72 which is operatively connected to the actuator 62 for generating suitable actuation signals that trigger the actuator to drive movement of the filter screen from the first configuration to the second configuration, and alternately from the second configuration to the first configuration. The controller 72 is a programmable computer controller including a processor and a memory storing programming instructions thereon which are executable by the processor to perform the various functions of the controller described herein. The controller generates actuation signals for the actuator according to programmed criteria to displace the screen member alternately between the first and second configurations at spaced intervals of time. For example, in one instance the controller may be programmed to flip the orientation of the screen from the first configuration to the second configuration or from the second configuration to the first configuration upon expiration of a timed duration corresponding to the expected amount of time for the screen to become plugged with particulate material collected thereon which obstructs the flow of the gaseous portion of the exhaust flow through the screen.

The controller can also operate in conjunction with a first pressure sensor 74 and a second pressure sensor 76 mounted in communication with the exhaust passage to measure pressure of the exhaust flow upstream and downstream of the filter screen respectively. More particularly, the first sensor 74 is mounted at the inlet side between the inlet opening and the filter screen, while the second sensor is mounted at the outlet side between the screen and the lid opening. Each of the sensors measures pressure and communicates a pressure signal to the controller. The controller can in turn calculate a pressure differential between the pressure measured by the first sensor 74 and the pressure measured by the second sensor 76 in which the pressure differential is indicative of a blockage of the exhaust flow through the filter screen resulting from particulate material collected on the filter screen.

The sensors and the controller continue to measure pressures and calculate pressure differentials on a real-time basis throughout operation of the apparatus while comparing the calculated pressure differential to a prescribed threshold limit stored on the controller in real time as well. The controller can then automatically actuate flipping the filter screen when the pressure differential exceeds the threshold. This arrangement of multiple pressure sensors and the controller functionality to calculate pressure differential indicative of blockage of the filter screen collectively defines a blockage sensor measuring blockage of the exhaust flow through the filter screen in which the calculated pressure differential constitutes a measure of blockage.

In use, the apparatus is mounted end to end in series between the exhaust discharge of a biomass furnace and the heated air intake of a grain dryer. The controller monitors the exhaust flow pressures and automatically actuates flipping of the filter screen when the controller determines that the filter screen is sufficiently blocked with collected particulate material that the gas flow is being impeded. Any sparks or embers which are collected on the screen will typically extinguish before flipping of the screen to the opposing configuration such that continued flow of exhaust through the screen in the opposing direction releases the extinguished particulate material previously collected one side of the screen while continuing to collect particulate material from the incoming exhaust flow on the new leading side of the screen. Discharged particulate material at the downstream side of the filter screen can be safely carried with the exhaust flow into the grain dryer once sparks or embers have been extinguished.

Since various modifications can be made in the invention as herein above described, and many apparently widely different embodiments of same made, it is intended that all matter contained in the accompanying specification shall be interpreted as illustrative only and not in a limiting sense.

1. A filtration apparatus for removing particulate material from an exhaust flow generated by combustion of biomass, the system comprising:
a housing defining an exhaust passage extending through the housing in a flow direction from an inlet opening arranged to receive the exhaust flow therein to an outlet opening arranged to discharge the exhaust flow therefrom;
a filter screen supported within the exhaust passage of the housing, the filter screen allowing the exhaust passage to pass therethrough between a first side of the filter screen and an opposing second side of the filter screen while preventing passage of the particulate material through the filter screen between the first side and the second side of the filter screen; and
an operating linkage supporting the filter screen and the housing to be movable relative to one another between (i) a first configuration in which the exhaust flow passes through the filter screen in the flow direction from the first side to the second side of the filter screen and (ii) a second configuration in which the exhaust flow passes through the filter screen in the flow direction from the second side to the first side of the filter screen.

2. The apparatus according to claim 1, further comprising an actuator operatively connected to the operating linkage so as to be arranged to drive movement of the operating linkage between the first configuration and the second configuration.

3. The apparatus according to claim 2, further comprising a controller operatively connected to the actuator so as to be arranged to alternately displace the operating linkage from the first configuration to the second configuration and from the second configuration to the first configuration at spaced apart intervals of time.

4. The apparatus according to claim 3, further comprising a blockage sensor arranged to measure blockage of the exhaust flow through the filter screen resulting from particulate material collected on the filter screen, wherein the controller is arranged to displace the operating linkage from the first configuration to the second configuration or from the second configuration to the first configuration in response to the measured blockage exceeding a prescribed threshold.

5. The apparatus according to claim 3, further comprising a first pressure sensor arranged to sense pressure of the exhaust flow between the inlet opening and the filter screen and a second pressure sensor arranged to sense pressure of the exhaust flow between the filter screen and the outlet opening, wherein the controller is arranged to calculate a pressure differential indicative of blockage of the exhaust flow through the filter screen resulting from particulate material collected on the filter screen, and wherein the controller is further arranged to displace the operating linkage from the first configuration to the second configuration or from the second configuration to the first configuration in response to the measured pressure differential exceeding a prescribed threshold.

6. The apparatus according to claim 1, wherein the filter screen is displaced relative to the inlet and outlet of the housing between the first configuration and the second configuration of the operating linkage.

7. The apparatus according to claim 6, further comprising one or more compressible gaskets supported on boundary walls of the exhaust passage so as to be engaged by the filter screen in sealing relationship between the filter screen and the boundary walls in each of the first configuration and the second configuration of the operating linkage.

8. The apparatus according to claim 6, wherein the filter screen is supported by the operating linkage for pivotal movement about a pivot axis relative to the housing between the first configuration and the second configuration.

9. The system according to claim 8, wherein the filter screen is pivoted about the pivot axis through a range of less than 90 degrees between the first configuration and the second configuration.

10. The apparatus according to claim 8, further comprising (i) a pivot shaft connected to the filter screen at the pivot axis, (ii) a crank arm supported externally of the exhaust passage and being connected to the pivot shaft to pivot with the filter screen about the pivot axis, and (iii) a linear actuator coupled to the crank arm to drive pivotal movement of the crank arm and the connected filter screen about the pivot axis between the first configuration and the second configuration.

11. The apparatus according to claim 8, wherein the filter screen is supported on a screen frame occupying a flat plane which is sloped relative to the flow direction at an angle of less than 45 degrees in each of the first and second configurations.

12. The apparatus according to claim 8, wherein the pivot axis is located at an intermediate location between diametrically opposing first and second ends of the filter screen.

13. The apparatus according to claim 12, wherein the pivot axis extends between first and second end boundary walls of the exhaust passage that are axially opposed from one another and wherein the exhaust passage further comprises first and second side boundary walls extending in a direction of the pivot axis between the first and second end boundary walls at opposing sides of the exhaust passage, wherein in the first configuration the first end of the filter screen is adjacent the first side boundary wall and the second end of the filter screen is adjacent the second side boundary wall, and wherein in the second configuration the first end of the filter screen is adjacent the second side boundary wall and the second end of the filter screen is adjacent the first side boundary wall.

14. The apparatus according to claim 1, wherein the filter screen comprises a metal wire mesh.

15. The apparatus according to claim 1, wherein the filter screen is supported on a screen frame, the filter screen being corrugated relative to the screen frame.
